(19) United States
(12) Patent Application Publication
(10) Pub. No.: US 2007/0027893 A1
(43) Pub. Date: Feb. 1, 2007

(54) Solution network automated symptom association

(76) Inventors: Dale Gundy, Round Rock, TX (US); David Bohl, Taylor, TX (US)

Correspondence Address: HAMILTON & TERRILE, LLP, P.O. BOX 203518, AUSTIN, TX, 78720, US

(21) Appl. No.: 11/183,715

(22) Filed: Jul. 18, 2005

(51) Int. Cl. G06F 7/00

(52) U.S. Cl. 707/102

(57) ABSTRACT

A method for automatically associating information with content in a solution network which includes identifying information used by a customer when attempting to resolve an issue, determining when the customer contacts a customer service technician based upon the issue, resolving the issue using content stored on the solution network, and automatically associating the information used by the customer with the content used to resolve the issue is disclosed.

### BACKGROUND OF THE INVENTION

1. Field of the Invention

The present invention relates to the field of customer support and more particularly to automating symptom association within a solution network.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

With the proliferation of information handling systems such as home and business computers, the provision of timely and efficient diagnostic, support, and maintenance services to end users has become an important issue for manufacturers and sellers of computer systems. It is not uncommon for end users, especially new users, or experienced users attempting to add or reconfigure existing systems, to experience difficulties with their systems. For example the system might lock up (often referred to as freezing up or hanging). Also for example, a peripheral of the computer system, such as a hard drive, disk drive, or printer, may not function properly. In other cases, the computer system may not recognize the peripheral. The solution to these sorts of problems may range from simply turning on power to the affected peripheral, reconnecting the affected peripheral, reconfiguring the computer system hardware or software, or installing a necessary software patch for the affected peripheral.

To diagnose and correct an issue, users typically have had to consult user's manuals that were included with the purchase of the system or peripheral. These manuals typically include troubleshooting tables or guides that attempt to diagnose a user's problem on the basis of symptoms recognized by the user. The effectiveness of the user's manual in assisting the users in identifying and correcting the problems encountered depends in large part on the skill of the computer user and the clarity and completeness of the user's manual. An inexperienced user may have difficulty in locating the source of the problem and in following the often confusing instructions in the user's manual. Moreover, user's manuals are often deficient in that they do not address every difficulty encountered by the user.

As an alternative or in addition to consulting a user's manual, a user experiencing difficulty with a system may consult diagnostic and support software stored locally on the system. The effectiveness of locally stored diagnostic software is limited in that the software programs generally display text files that have information similar to that found in user's manuals. As a result, users attempting to diagnose computer system problems through locally stored software programs face limitations similar to those faced by users attempting to diagnose system problems through a user's manual.

As another alternative, users may have access to a support or help line. A support or help line requires that the user contact a support technician or specialist at a central site. The support technician listens to the user's symptoms and attempts to diagnose the problem. This process often involves the support technician stepping the user through a series of diagnostic tests. If appropriate, the support technician may provide the user with instructions or tips for correcting the problem. The effectiveness of interpersonal diagnostic and support services of this sort depends in large part on the skill of the user being assisted. Regardless of the skill and knowledge of the support technician, the user will nevertheless have to describe correctly the problem being experienced, assist the support technician in diagnosing the problem, and perform the fix or correction suggested by the support technician.

One issue relating to the support system relates to enabling customers to easily or repeatably access solutions. In known solution networks, a customer's inability to locate a solution often results in a call to customer support. There are a number of reasons why a customer might not be able to locate a solution. For example, often there may be a disconnect between the content authors and the customer's perceived symptoms. Additionally, a content author may have a poor choice of keywords by which the content is identified. Also, there may be poor attribute management on the content (i.e., the content may not be associated with newer versions of a product). An additional challenge with maintaining content relates to the large increase in the amount of technical content and number of supported products for a particular solution network.

In known solution networks, maintaining a successful knowledge base often requires a significant manual effort in tying appropriate keywords and attributes to solutions. This workload often becomes a bottleneck in the content creation process, which reduces the resource pool we have to identifying content gaps and collecting solutions to address these gaps. In one known customer support system, a large number (e.g., more than half) of all technical calls are soft calls (i.e., calls that do not require a dispatch) and these largely could be averted with the appropriate content on a customer accessible solution network.

In a known solution network, a knowledge base is updated via technology which harnesses technicians search terms; however, technician search terms may not translate well to external customers. For example, technicians often use acronyms and known shortcuts to access content that is not well known by the customer. Thus, the technology may not gain any benefit from learning these symptoms. Additionally, in such a system there is no business threshold to keywords. Symptoms to content associations get created immediately without any business logic, potentially leading to inappropriate symptoms or keywords added to the content. Additionally, such a system does not aid in document attribute management. Additionally, such a system does not take success/failure metrics into account. If a technician uses a solution that is not valid for the customer's symptom, which often results in a repeat contact, then the symptom should not be linked to the solution. If a frequency threshold is not met within the processing cycle, the association and frequency are recorded in a reporting interface and the frequency number is zeroed out.

### SUMMARY OF THE INVENTION

In accordance with the present invention, a knowledge management system is provided with an automated symptom discovery module which associates customer keywords with potential solutions. The automated symptom discovery module includes a business threshold for use with keywords. Additionally, in an embodiment, the automated symptom discovery module aids in document attribute management by taking success/failure metrics into account before an association between keywords and solutions is created. If a technician uses a solution that is not valid for the customer's symptom as indicated by a repeat contact, then the symptom is not linked to the solution. Additionally, in an embodiment, if a frequency threshold is not met within the processing cycle, the association and frequency are recorded in a reporting interface and the frequency number is zeroed out.

More specifically, the symptom discovery engine identifies web-to-phone failures and captures the customers search terms and attributes selected during the customer's online session. These search terms and attributes are then carried to the subsequent internal technician's solution network session. The automated symptom discovery engine analyzes whether these keywords and attributes already exist on the content that resolved the customer's issue. If the keywords and attributes are not linked to the appropriate solution, the keyword to content and attribute to content relationships are saved in the system for later processing. The frequency of these associations are calculated on a regular cycle and compared to a business threshold set through an administration console. If the frequency threshold is met or exceeded, the keyword and or attributes are programmatically linked to the content, thus improving subsequent searches.

In one embodiment, the invention relates to a method for automatically associating information with content in a solution network which includes identifying information used by a customer when attempting to resolve an issue, determining when the customer contacts a customer service technician based upon the issue, resolving the issue using content stored on the solution network, and automatically associating the information used by the customer with the content used to resolve the issue.

In another embodiment, the invention relates to an apparatus for automatically associating information with content in a solution network which includes means for identifying information used by a customer when attempting to resolve an issue, means for determining when the customer contacts a customer service technician based upon the issue, means for resolving the issue using content stored on the solution network, and means for automatically associating the information used by the customer with the content used to resolve the issue.

In another embodiment, the invention relates to a method for associating information with content in a solution network which includes identifying a keyword used by a customer when attempting to resolve an issue, identifying an attribute associated with the customer, determining when the customer contacts a customer service technician based upon the issue, resolving the issue using content stored on the solution network, associating the keyword used by the customer with the content used to resolve the issue, and associating the attribute associated with the customer with the content used to resolve the issue.

In another embodiment, the invention relates to an apparatus for associating information with content in a solution network which includes means for identifying a keyword used by a customer when attempting to resolve an issue, means for identifying an attribute associated with the customer, means for determining when the customer contacts a customer service technician based upon the issue, means for resolving the issue using content stored on the solution network, means for associating the keyword used by the customer with the content used to resolve the issue, and means for associating the attribute associated with the customer with the content used to resolve the issue.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of a solution environment.

FIG. 2 shows a block diagram of a solution network.

FIG. 3 shows a flow chart of the operation an automated symptom discovery module.

FIG. 4 shows a flow chart of the operation of a symptom portion of the automated symptom discovery module.

FIG. 5 shows a flow chart of the operation of an attribute portion of the automated symptom discovery module.

### DETAILED DESCRIPTION

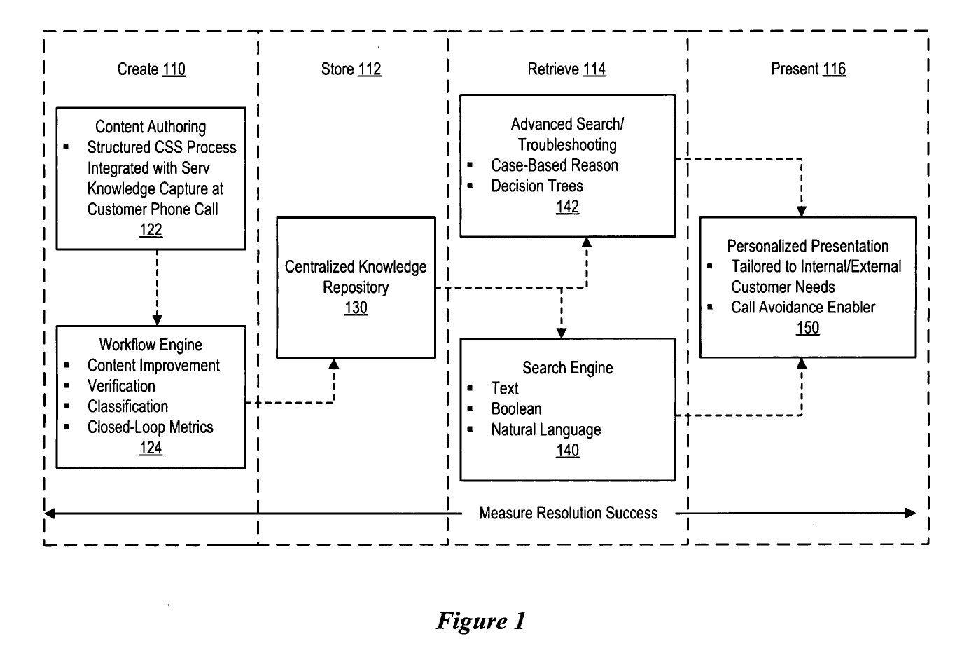

Referring to FIG. 1, a block diagram of the solution environment 100 is shown. More specifically, the solution environment 100 includes a create portion 110, a store portion 112, a retrieve portion 114 and a present portion 116.

The create portion 1O provides an environment in which knowledge is created. More specifically, the create portion 110 includes a content authoring portion 120 and a workflow engine portion 122. The content authoring portion provides a structured customer service and support (CSS) process which is integrated with a solution network server. The content authoring portion 122 also includes a knowledge capture portion which enables knowledge capture during communication with a customer. The workflow engine portion 124 provides a content improvement function, a knowledge verification function, a knowledge classification function as well as closed loop metrics for knowledge creation.

The store portion 112 provides the environment in which knowledge is stored. More specifically, the store portion 112 includes a centralized knowledge repository 130 in which knowledge that is created in the create portion 110 is stored.

The retrieve portion 114 provides the environment in which knowledge is retrieved. More specifically, the retrieve portion includes a search engine 140 in which various types of searches may be performed on the centralized knowledge repository 130. The searches may be in the form of, e.g., text searches, Boolean searches or natural language searches, etc. The retrieve portion also includes an advanced search and troubleshooting portion 142 which provides case based reason function as well as a decision tree function.

The present portion 116 provides the environment in which support knowledge is presented to a customer. More specifically, the present portion 116 provides a personalized presentation 150 of support knowledge. This information may be tailored to the internal or external customer needs. Providing a personalized presentation 150 becomes a call avoidance enabler in that a personalized presentation may enable a customer to obtain an answer to a problem without the need for a specific call to customer support.

The solution environment streamlines resource usage and enhances knowledge mining capabilities by eliminating the need for a third party or disconnected content creation group. The environment enables content creation applicable to the customer and business needs by integrating the content creation process and the call center technician phone intake process. The technical information is removed from a customer management tool and placed in a repository that can be used by other technicians. The environment thus enables continual use which allows the technical repository to evolve and grow while focusing knowledge mining on confirmed applicable incidents as compared to a perceived need.

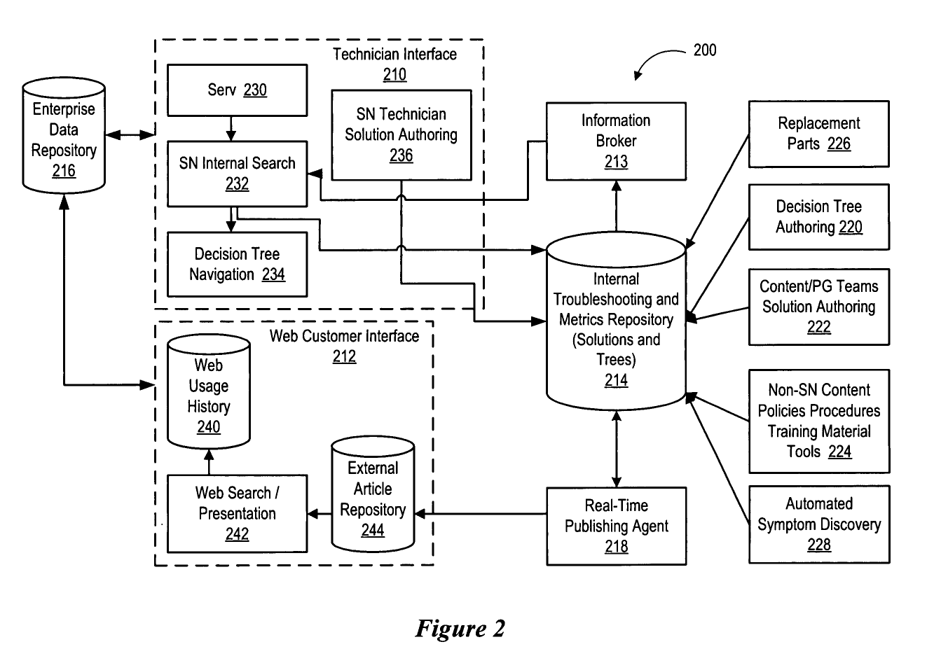

Referring to FIG. 2, a block diagram of a solution network 200 which instantiates the solution environment is shown. More specifically, the solution network 200 includes a technician interface module 210, a customer interface module 212, an information broker 213, an internal repository 214, an enterprise data repository 216, a real time publishing agent 218, a decision tree authoring module 220, a content/PG teams solution authoring module 222, a Non-solution network (Non-SN) content module 224 and a replacement parts module 226. The technician interface module 210 is coupled to the enterprise data repository 216, to the customer interface module 212 and to the information broker 213 as well as to the internal repository 214. The internal repository 214 is coupled to the information broker 213 and the real time publishing agent 218 as well as the decision tree authoring module 220, the content/PG teams solution authoring module 222, the Non-solution network (Non-SN) content module 224, the replacement parts module 226 and an automated symptom discovery module 228. The real time publishing agent 218 is coupled to the customer interface 212.

The technician interface module 210 provides the user interface function between the technician and the solution network system 200. The customer interface module 212 provides the interface function for customers to the solution network system 200. The information broker 213 accesses information from the internal repository 214 and provides this information to the technician interface 210. The internal repository 214 provides a repository for troubleshooting solutions (both solutions and solution trees) as well as metrics relating to the solution network. The troubleshooting solutions may include articles, decision trees, and policies. The information broker 213 determines a best answer for a user based upon the user's answers to questions presented by the technician. The solution may be an action, such as rebooting the customer system, or the solution may be an actual part that needs to be replaced on the customer system. In the case of a part, the part number may be listed as the solution within the internal repository 214.

The enterprise data repository 216 is a customer database which includes histories on a customer including what system the customer has purchased, the components included with the system, profile history (i.e., contact information) as well as prior service history, prior rendered solutions and prior web support activity. Linking this customer information with the solution network 200 enables generating a solution faster and with fewer questions to the customer. Additionally, providing the component information to the solution network 200 enables solutions to be rendered that may be component specific. Additionally, maintaining service history on a customer basis enables the solution network 200 to tailor customer specific solutions as well as monitoring whether a particular customer is trying to take advantage of the service provider by obtaining excess replacement components.

The real time publishing agent 218 enables the solution network 200 to release knowledge immediately while the solution network 200 is running. Thus, technicians and customers have access to solutions stored within the repository 214 as soon as the solution is released, without having to wait for a new publish cycle to occur.

The technician interface 210 includes a server module 230, an internal search module 232, a decision tree navigation module 234 and a SN technician solution authoring module 236. The server module 230 provides the service on which the technician interface 210 resides. The SN internal search module 232 receives customer described issue and searches the internal repository 214 for possible solutions. The search module 232 systematically converts how a customer describes an issue into searchable keywords. For example, if a customer call and informs the technician that the customer system will not turn on, the search module may convert this to a technical search for solutions relating to a “No Power on Self Test (POST)” condition. The decision tree navigation module 234 controls the way that branches on a solution network decision tree are rendered. The technician solution authoring module 236 enables a technician to modify or augment a solution provided by the repository in real time (i.e., provide the modification or augmentation to the repository while the technician is interacting with a customer). A particular line of business can see these augmentations either immediately or after release from incubation. The level of incubator at which the line of business is notified is customizable depending on the desires of each line of business.

The customer interface 212 is, for example a web customer interface, which is accessible via the internet. The customer interface 212 includes a web usage history module 240, a web search and presentation module 242 and an external article repository 244. The web usage history module 240 maintains a history of the interaction between a customer and the solution network 200. This history is maintained so that if an issue is forwarded from the customer interface 212 to the technician interface 210, the technician can easily determine what questions or answers have already been tried by the user when attempting self-help via the customer interface 212 before enlisting technician assisted support. The web search/presentation module 242 is the module with which the customer interacts when accessing the customer interface 212. The external article repository 244 is a repository of documents that have been released for public access.

The decision tree authoring module 220 stores information within the repository 214 which enables knowledge to be linked together in a process oriented fashion. The content/PG team's solution authoring module 222 enables the authoring of stand alone knowledge solutions and applies the appropriate attributes to this knowledge. The Non-solution network (Non-SN) content module 224 stores information regarding policies and procedures within the repository 214. For example, a particular customer might have certain associated business policies that a technician might be expected to apply. The Non-SN content module 224 thus essentially applies a filter to particular customer situations. The Non-SN content module 224 also includes training material for training support technicians. This training material includes extra support detail than is provided to technicians who are interacting with customers. The Non-SN content module 224 also provides a conduit into other support tools that might not have been stored within the repository 214. The replacement parts module 226 develops solutions relating to which replacement parts are associated with particular systems.

The solution network 200 includes a decision tree module which includes a decision tree search portion which is instantiated within the internal search module 232 and web search module 242 and an authoring portion which is instantiated within the decision tree authoring module 220.

The decision tree search portion allows both novice and experienced level users to efficiently use the solution network by using implied success. Trees are rendered in a format that allows a novice level user to navigate through trouble shooting steps one step at a time while a more experienced level user has the ability to pick and choose which steps to use. The troubleshooting steps are rendered in a hierarchical view that can be bypassed by skipping steps (i.e., by implied success). The search portion also includes a self learning symptom based search using the customer's perception of an issue. The decision tree links and strengthens or lessens relevancies of trees to customer symptoms (perceptions). Trees are also searchable by viewing a hierarchical view of trees organized based upon business needs. The decision tree search portion also provides a troubleshooting tool; all steps within the decision tree are stand alone knowledge searchable and viewable as individual articles as well as trouble shooting trees.

The authoring portion of the decision tree module provides a dynamic tool that reuses content and renders content based on the symptom and requested environmental variables. The tool provides knowledge authors with the ability to link together existing knowledge articles creating troubleshooting trees or creating new articles available for use through searching the knowledge base or in other trees. The authoring portion enables knowledge authors to crate content and troubleshoot trees by viewing the content in a process flow. The authoring portion of the decision tree module is web enabled to allow dragging and dropping of content, creating relationships and creating individual knowledge articles. The authoring portion of the decision tree module is dynamic to enable content reviewers to not only review individual pieces of knowledge but also the relationships of knowledge. If a step is changed that is associated with 10 trees, then not only should the step be reviewed, but all 10 trees should also be reviewed to ensure that the content relationship is still valid.

The automated symptom discovery module 228 associates customer keywords with potential solutions. The automated symptom discovery module 228 includes a business threshold for use with keywords. Additionally, the automated symptom discovery module 228 aids in document attribute management by taking success/failure metrics into account before an association between keywords and solutions is created. If a technician uses a solution that is not valid for the customer's symptom as indicated by a repeat contact, then the symptom is not linked to the solution. Additionally, if a frequency threshold is not met within the processing cycle, the association and frequency are recorded in a reporting interface and the frequency number is zeroed out.

More specifically, the symptom discovery module 228 identifies web-to-phone failures and captures the customers search terms and attributes selected during the customer's online session. These search terms and attributes are then carried to the subsequent internal technician's solution network session. The automated symptom discovery module 228 analyzes whether these keywords and attributes already exist on the content that resolved the customer's issue. If the keywords and attributes are not linked to the appropriate solution, the keyword to content and attribute to content relationships are saved in the system for later processing. The frequency of these associations are calculated on a regular cycle and compared to a business threshold set through an administration console. If the frequency threshold is met or exceeded, the keyword and or attributes are programmatically linked to the content, thus improving subsequent searches.

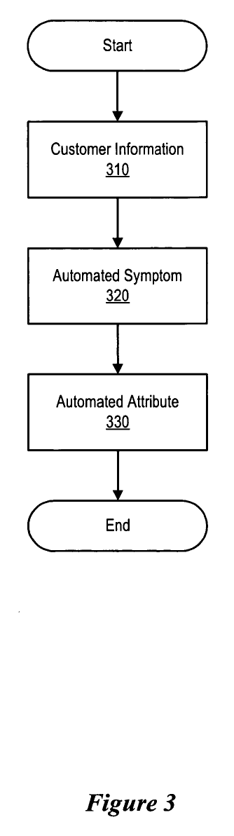

Referring to FIG. 3, a flow chart of the operation of the automated symptom discovery module 228 is shown. More specifically, the automated symptom discovery module 228 is initiated when a customer contacts a customer support representative after having tried to answer a question using the web customer interface 212. The automated symptom discovery module 228 determines initial customer information at step 310. The initial customer information may be determined based upon the service tag of the customer system. This service tag information is also determined during a customer's online session and so information relating to the customer's online session is also associated with the service tag information.

The automated symptom discovery module 228 starts by performing an automated symptom analysis at step 320. The automated symptom analysis uses information relating to the customer's online session to determine whether to associate particular keywords with a particular solution.

After the automated symptom analysis is performed, the automated symptom discovery module performs an automated attribute analysis at step 330. The automated attribute analysis uses attribute information based upon the customer system service tag to determine whether to associate one or more attributes with a particular solution.

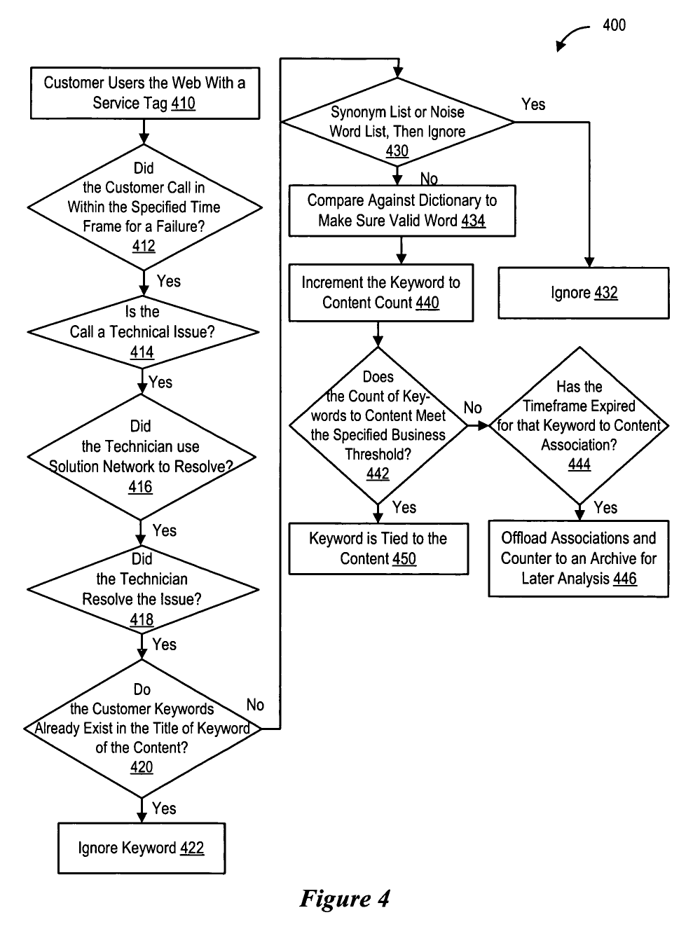

Referring to FIG. 4, a flow chart of the operation of the automated symptom analysis module 400 of the automated symptom discovery module 228 is shown. More specifically, when a customer uses the web customer interface 212 with a system having a service tag (or other unique identifier) at step 410, the automated symptom discover module starts a timer. Next, the automated symptom analysis module 400 determines whether the customer contacted a customer service representative within a specified time frame for a failure at step 412. Such a contact indicates that the customer contact is likely related to the issue for which the customer contacted the web customer interface 212.

Next the automated symptom analysis module 400 determines whether the contact is for a technical issue at step 414. If so, then the symptom analysis module 400 determines whether the technician used the solution network 200 to resolve the customer's issue at step 416. Next, the symptom analysis module 400 determines whether the technician resolved the customer's issue at step 418.

Next, at step 420, the symptom analysis module 400 determines whether the customer's keywords are already present in the title of the content or the keyword association for the content. The keywords being present indicate that the customer's search did present the content of the solution that the technician identified and thus the keyword is ignored by the automated symptom analysis module 400 at step 422.

Next, at step 430, the symptom analysis module 400 determines whether the keyword or words is present on a synonym word list or a noise word list. Synonym words are words whose synonyms are already present in the keyword association for the solution content. Noise words are words which are not searchable (e.g., and, or) or words which have no meaning in the context of the symptom search (e.g., cuss words). If so, then the keyword is ignored by the automated symptom analysis module 400 at step 432.

Next the keyword or words are compared against a dictionary to make sure that the word is a valid word at step 434. This search assures that the keyword or words were not just a combination of keys (e.g., asdf or other common keyword combinations) or were not a typo.

If the keyword or words pass these tests, then the keyword is a valid keyword and the symptom analysis module 400 increments the keyword to content count at step 440. The symptom analysis module 400 then determines whether the count of the keywords to content count meets or exceeds a specified business threshold at step 442. This threshold is set by an administrator based upon business determinations for the solution network. So for example, it might be determined to not enter a keyword association unless more than three customers use the same keyword or keyword combination within a certain amount of time.

If the count of the keywords does not meet or exceed the threshold, then the symptom analysis module 400 determines whether a timeframe has expired for the keyword to content association at step 444. If the timeframe has expired, then the symptom analysis module 400 offloads the associations and counter to an archive for alter analysis at step 446. The timeframe expiring indicates that the use of the particular keyword or keyword combination is infrequent enough to not warrant association with the content. The later analysis may determine whether the frequency of the use of a particular keyword for which an association is created should be increased or decreased.

If the count of the keywords meets or exceeds the threshold, then the keyword is associated with the content at step 450.

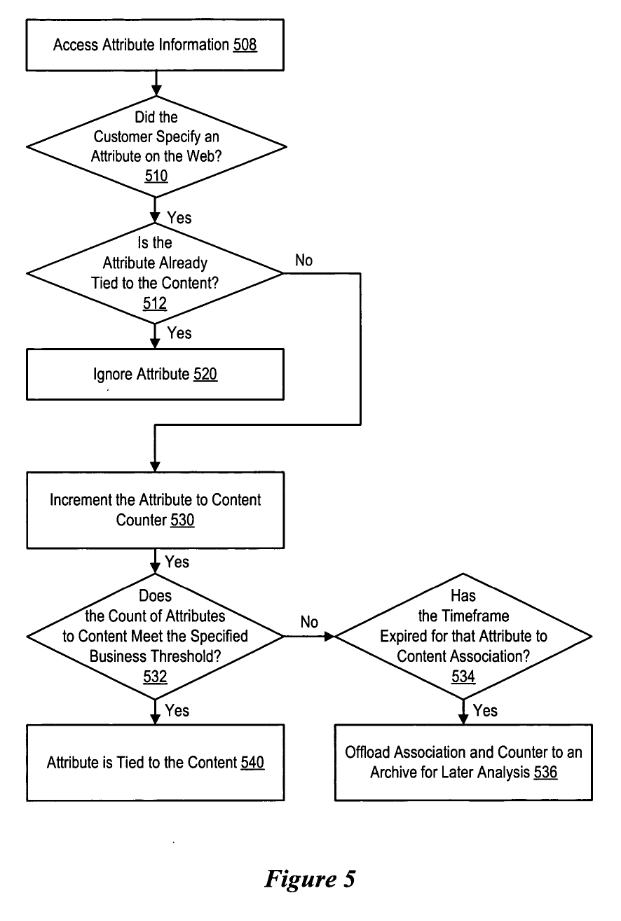

Referring to FIG. 5, a flow chart of the operation of an attribute analysis module 500 of the automated symptom discovery module is shown. More specifically, when a customer uses the web customer interface 212 with a system having a service tag (or other unique identifier) at step 410, the attribute analysis module 500 identifies attribute information about the customer system at step 508. Next, the automated attribute analysis module 500 determines whether the customer specified any attribute information during the web customer session at step 510. Attribute information may include system identification information such as a system model number, type of hardware installed on the system etc., as well as software identification information such as the type of software installed on the system and the version of software installed on the system.

Next the automated attribute analysis module 500 determines whether the attribute is already associated with the content at step 512. If the attribute is already associated with the content, then the attribute analysis module 500 ignores the attribute for purposes of automatically associating attributes with content at step 520.

If the attribute is not already associated with the content then the attribute analysis module 500 increments the attribute to content count at step 530. The attribute analysis module 500 then determines whether the count of the attribute to content count meets or exceeds a specified business threshold at step 442. This threshold is set by an administrator based upon business determinations for the solution network. So for example, it might be determined to not enter an attribute association unless more than three customers contact with solution network with the same attribute or combination of attributes.

If the count of the keywords does not meet or exceed the threshold, then the attribute analysis module 500 determines whether a timeframe has expired for the attribute to content association at step 534. If the timeframe has expired, then the attribute analysis module 500 offloads the associations and counter to an archive for later analysis at step 536. The timeframe expiring indicates that the use of the particular attribute or combination of attributes is infrequent enough to not warrant association with the content. The later analysis may determine whether the frequency of the use of a particular attribute for which an association is created should be increased or decreased.

If the count of the attributes meets or exceeds the threshold, then the attribute or combination of attributes is associated with the content at step 540.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the decision tree module can be modified to support decision trees in different languages. For example, FIG. 9 shows the operation of process for supporting a decision tree with a plurality of languages. When an English tree is promoted, e.g., via step 420, then the decision tree enters the process to determine whether to translate the tree into a plurality of additional languages. Each language includes a corresponding translation and review process. The tree may be translated into multiple languages either serially or in parallel.

Also, for example, the above-discussed embodiments include software modules that perform certain tasks. The software modules discussed herein may include script, batch, or other executable files. The software modules may be stored on a machine-readable or computer-readable storage medium such as a disk drive.

Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for automatically associating information with content in a solution network comprising:
identifying information used by a customer when attempting to resolve an issue;
determining when the customer contacts a customer service technician based upon the issue; and,
resolving the issue using content stored on the solution network; and,
automatically associating the information used by the customer with the content used to resolve the issue.

2. The method of claim 1 wherein:
the information includes a keyword used to search the content stored on the solution network.

3. The method of claim 2 wherein:
the information includes an attribute, the attribute being from a system for which the issue is related.

4. The method of claim 2 further comprising:
determining a number of contacts for which the information is related to the issue; and,
associating the information used by the customer with the content only when the number of times exceeds a predetermined number of contacts.

5. The method of claim 1 wherein:
the determining when the customer contact is based upon the issue includes analyzing a time from when the customer attempts to resolve the issue.

6. The method of claim 1 wherein:
the issue relates to an information handling system.

7. An apparatus for automatically associating information with content in a solution network comprising:
means for identifying information used by a customer when attempting to resolve an issue;
means for determining when the customer contacts a customer service technician based upon the issue; and,
means for resolving the issue using content stored on the solution network; and,
means for automatically associating the information used by the customer with the content used to resolve the issue.

8. The apparatus of claim 7 wherein:
the information includes a keyword used to search the content stored on the solution network.

9. The apparatus of claim 8 wherein:
the information includes an attribute, the attribute being from a system for which the issue is related.

10. The apparatus of claim 8 further comprising:
means for determining a number of contacts for which the information is related to the issue; and,
means for associating the information used by the customer with the content only when the number of times exceeds a predetermined number of contacts.

11. The apparatus of claim 7 wherein:
the means for determining when the customer contact is based upon the issue includes means for analyzing a time from when the customer attempts to resolve the issue.

12. The apparatus of claim 7 wherein:
the issue relates to an information handling system.

13. A method for associating information with content in a solution network comprising:
identifying a keyword used by a customer when attempting to resolve an issue;
identifying an attribute associated with the customer;
determining when the customer contacts a customer service technician based upon the issue; and,
resolving the issue using content stored on the solution network; and,
associating the keyword used by the customer with the content used to resolve the issue; and,
associating the attribute associated with the customer with the content used to resolve the issue.

14. The method of claim 13 wherein:
the attribute includes information relating to a system for which the issue is related.

15. The method of claim 13 further comprising:
determining a number of contacts for which the keyword is related to the issue; and,
associating the keyword used by the customer with the content only when the number of times exceeds a predetermined number of contacts.

16. The method of claim 13 wherein:
the determining when the customer contact is based upon the issue includes analyzing a time from when the customer attempts to resolve the issue.

17. The method of claim 13 wherein:
the issue relates to an information handling system.

18. An apparatus for associating information with content in a solution network comprising:
means for identifying a keyword used by a customer when attempting to resolve an issue;
means for identifying an attribute associated with the customer;
means for determining when the customer contacts a customer service technician based upon the issue; and,
means for resolving the issue using content stored on the solution network; and,
means for associating the keyword used by the customer with the content used to resolve the issue; and,
means for associating the attribute associated with the customer with the content used to resolve the issue.

19. The apparatus of claim 18 wherein:
the attribute includes information relating to a system for which the issue is related.

20. The apparatus of claim 18 further comprising:
means for determining a number of contacts for which the keyword is related to the issue; and,
means for associating the keyword used by the customer with the content only when the number of times exceeds a predetermined number of contacts.

21. The apparatus of claim 18 wherein:
the means for determining when the customer contact is based upon the issue includes means for analyzing a time from when the customer attempts to resolve the issue.

22. The apparatus of claim 18 wherein:
the issue relates to an information handling system.
